(19) United States
(12) Patent Application Publication
(10) Pub. No.: US 2004/0222542 A1
(43) Pub. Date: Nov. 11, 2004

(54) Method of making light weight board of improved mechanical strength

(75) Inventors: Tzy-Cherng Jan, Basking Ridge, NJ (US); Jyh-yao Raphael Li, Parsippany, NJ (US); Haur-Horng Yang, Victoria, TX (US)

Correspondence Address: Raphael Li, World Pak Division / Inteplast Group Ltd., 9 Peach Tree Hill Rd., Livingston, NJ, 07039, US

(73) Assignee: Inteplast Group, Ltd., Livingston, NJ

(21) Appl. No.: 10/831,577

(22) Filed: Apr. 26, 2004

Related U.S. Application Data
(62) Division of application No. 09/902,317, filed on Jul. 10, 2001, now abandoned.

(51) Int. Cl. B29C 47/12

(52) U.S. Cl. 264/70; 264/177.1; 264/235

(57) ABSTRACT

The present invention is an extruded hollow thermoplastic sheeting, which is made of a pair of flat and parallel sheets spaced apart and interconnected by extending ribs of shifted patterns, e.g. of a sigmoid pattern, is disclosed in this invention. The thermoplastic sheeting of the invention has stronger tear strength and balanced physical properties as compared to hollow thermoplastic sheeting with extending ribs of straight pattern of the same specification. The present invention also provides a method for production thereof, wherein a fixing and cooling assembly is oscillated relative to a die, or vice versa, to create the ribs of shifted patterns.

This application is a divisional application of Ser. No. 09/902,317, filed Jul. 10, 2001.

### BACKGROUND OF THE INVENTION

1. Field of the Invention

The present invention relates to extruded thermoplastic sheeting consisting of a pair of sheets or layers spaced apart and interconnected by extending ribs so that the interior of the boards contains a plurality of extending passageways. More particularly, it relates to thermoplastic sheeting consisting of a pair of sheets or layers, which are substantially parallel to each other and are interconnected by extending ribs of shifted pattern, such as sigmoid pattern. The hollow thermoplastic sheeting of the present invention enhances the tear strength and balances the mechanical strength in the along passageway direction (hereinafter referred to as MD) and cross passageway direction (hereinafter referred to as CD) of thermoplastic sheeting in the prior arts. The present invention also relates to the process for production thereof.

2. Description of the Prior Art

Hollow thermoplastic panels, which are made of thermoplastic resin and may be used to replace corrugated paperboards, are already known to those skilled in the art.

A method in the prior arts, such as U.S. Pat. No. 3,509,005, No. 3,664,906, No. 3,748,217 and No. 3,741,857, for the manufacture of such lightweight board integrally molds a sheet with a plurality of ribs extending from the surface of the sheet. Another sheet of plain structure or having a plurality of extending ribs from the surface of the sheet can be bonded to previous sheet by bringing the two sheets together under heat-softened conditions such that the two sheets heat bond to one another.

U.S. Pat. No. 5,910,226 and No. 3,837,973 use a method for the manufacture of the hollow thermoplastic boards, which consists of three extruders. The material from the middle extruder is molded into shapes by a roller and is united with the films from the other two extruders into one member by fusing together while they are under heat-softened conditions.

In the previous techniques described above, a pressure is applied when the sheets are united together by fusion state connection at their mutually contacting parts in the previous techniques. Therefore, the joints of the constituent members represent naturally weaker points than other parts of the thus produced panel or boards.

To avoid the problem of weak joints in the prior techniques, U.S. Pat. No. 3,274,315, No. 3,792,951, No. 4,513,048 and No. 5,658,644 use a process, which integrally extrude the two sheets and the plurality of the ribs of the hollow thermoplastic board through an extrusion orifice having a corresponding orifice configuration. The extruded boards then enter a calibrator, which cools and shapes the dimension of the board. The boards manufactured by such method consist of a pair of sheets or layers spaced apart and interconnected by longitudinally extending ribs so that the interior of the boards contains a plurality of extending straight passageways.

The plastic hollow lightweight boards manufactured by the above method, however, have unbalanced physical properties. Due to the configuration of the passageway structure and the alignment of plastic molecule, the boards in the direction parallel to the passageways or machine direction have strong stacking and flexural strengths, but have weak tear strength. In the direction cross the passageway or transverse direction, the flexural and stacking strengths are weak and tear resistance is strong.

The thermoplastic hollow lightweight boards as a replacement for corrugated paperboards are generally converted to plastic boxes for packaging. In a regular slotted box, there are top, bottom and four side panels, which provide the stacking strength of the box. The passageways in the four side panels of the box are generally vertical to fully utilize the strong stacking and flexural strengths in the MD. However, the boxes made of hollow thermoplastic boards are tended to tear along the passageway direction due to the weak tear strength in the MD and are dismantled.

The hollow thermoplastic boards are also used in stacking bottles or cans on pallets as tier sheets to separate the layers of bottles or cans and to support the weight above the sheet. Due to the weak flexural strength in the cross passageway direction, the tier sheets tend to bend in the CD direction and incur dropping of bottles or cans above the tier sheet.

In addition, the hollow thermoplastic boards are regularly converted to form boxes, containers, decoration parts, etc. by using cutting and scoring blades. Since the boards have longitudinally extended ribs, the cutting and scoring blades in the passageway direction may contact either the areas between two ribs, which are soft, or the ribs, which are comparatively more rigid. As a result, the qualities of the cutting or scoring lines of the thermoplastic sheets are inconsistent, which make forming or folding the boards into final products, such as boxes, difficult.

In order to overcome the above shortcomings and to balance the imparity of the mechanical strength of the hollow thermoplastic boards in the machine and cross passageway directions, boards formed of a pair of sheets or layers, which are substantially parallel to each other, and are interconnected by extending ribs of shifted pattern and the corresponding process for the production thereof are disclosed in this invention, which are neither taught nor rendered obvious by the prior art.

Notwithstanding the prior art, the present invention is neither taught nor rendered obvious thereby.

### SUMMARY OF THE INVENTION

An extruded hollow thermoplastic board is disclosed which has a pair of flat and parallel sheets spaced apart and interconnected by extending ribs. The ribs of the boards have shifted patterns, such as zig-zag patterns, saw-tooth patterns, block-wave patterns, continuous-wave patterns and other sigmoid patterns, which significantly enhance tear strength along the passageway direction and the flexural and bending strengths of the board in the cross passageway direction. By the term “shifted patterns” is meant any patterns which are not straight line patterns, especially those of repeated segments. Thus, there is no straight line hollow passageway created in the present invention hollow thermoplastic boards due to the shifted patterns of the ribs. Consequently, the hollow thermoplastic boards in the present invention balance the strong imparity of the mechanical strength of the boards in the prior art. The unexpected benefit of the boards with balanced mechanical properties is the consistent quality of the cutting and scoring lines, which improves the efficiency of converting the boards into boxes, containers, etc. The present invention also provides methods for the manufacture of the hollow thermoplastic containing ribs of shifted patterns.

### BRIEF DESCRIPTION OF THE DRAWINGS

The present invention should be more fully understood when the specification herein is taken in conjunction with the drawings appended hereto wherein:

The features of the present invention, which are believed to be novel, are set forth with particularity in the appended claims. The invention may best be understood by reference to the following description taken in conjunction with accompanying drawings, wherein like reference numerals identify like elements and wherein:

FIG. 1 is a perspective view of parts of prior art hollow thermoplastic boards consisting of a pair of sheets or layers, which are spaced apart and interconnected by longitudinally extended ribs.

FIG. 2 shows a top, cut, partial view of prior art board shown in FIG. 1 to illustrate the straight line (unshifted) ribs.

FIGS. 3a, 3b, and 3c show shifted patterns of some of the boards of the present invention.

FIG. 4 is a perspective view of parts of hollow thermoplastic boards consisting of a pair of sheets or layers, which are spaced apart and interconnected by extended ribs of sigmoid pattern.

FIG. 5 is a schematic drawing of the process for the production of hollow thermoplastic boards consisting of a pair of sheets or layers, which are spaced apart and interconnected by extended ribs of shifted pattern, of the present invention.

FIG. 6 is a schematic drawing of the process in the other embodiments for the production of hollow thermoplastic boards consisting of a pair of sheets or layers, which are spaced apart and interconnected by extended ribs of shifted pattern, of the present invention.

FIG. 7 is a sectional view of pans of the die lip which produces hollow thermoplastic sheeting which consists of a pair of sheets or layers, which are flat and substantially parallel, spaced apart and interconnected by extending ribs, which are substantially vertical to the two flat sheets.

FIGS. 8 through 10 are sectional views of parts of several types of hollow thermoplastic boards, which can be made to have ribs of shifted pattern by the process of present invention.

### DETAILED DESCRIPTION OF THE PRESENT INVENTION

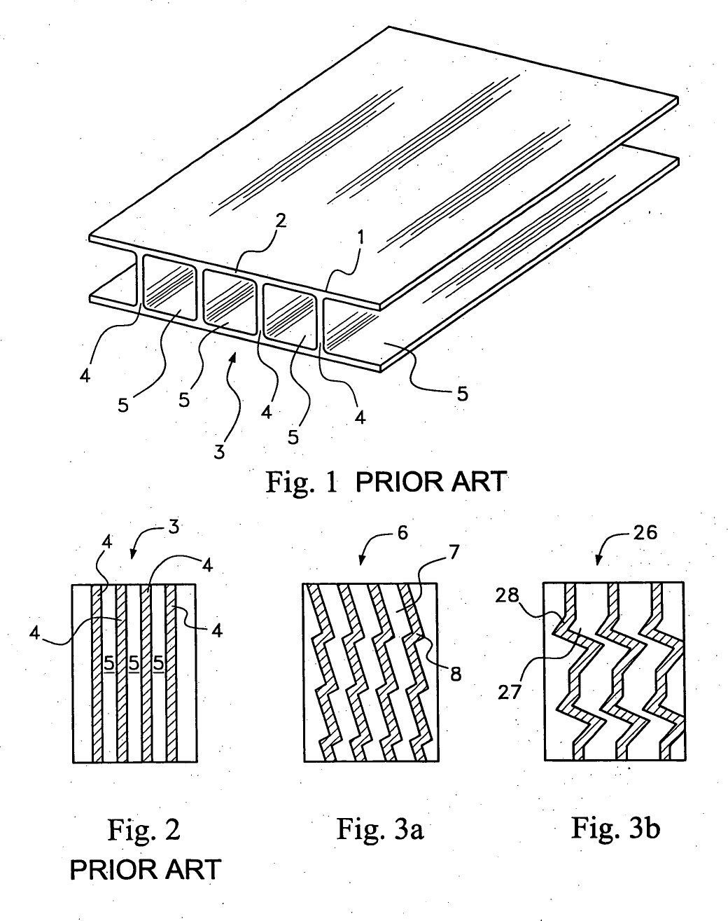

FIG. 1 illustrates a hollow thermoplastic sheeting of the prior art. The sheeting (1) consists of a first planar sheet (2) and a second planar sheet (3), which is substantially parallel to the first planar sheet with the inwardly facing surfaces of sheets (2) and (3) integrally interconnected by a plurality of longitudinal extending ribs. Within the sheeting, the combination of the inwardly facing surfaces of the sheets (2) and (3) and the adjacent surfaces of a pair of ribs (4) define elongated and rectangular passageways or ducts (5).

FIG. 2 shows a top cut view of the board shown above in FIG. 1 with the first planar sheet (2) removed. Thus, second planar sheet (3), ribs (4) and passageways (5) clearly show the unshifted (straight line) path of the ribs.

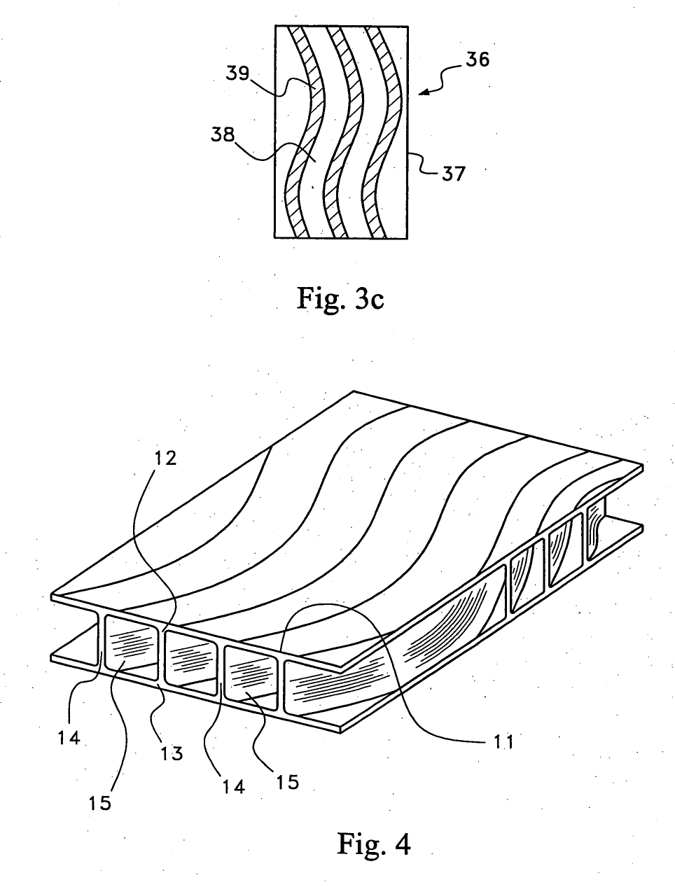

FIGS. 3a, 3b, and 3c show top cut views of examples of ribs having patterns in accordance with the present invention. Thus, in FIG. 3a, a sawtooth pattern is achieved by a shift in one direction and then an abrupt shift in the opposite direction for a shorter period of time, followed by a return to the first shift. Planar sheet (6) includes passageways (7) and ribs (8) of shifted patterns. Likewise, in FIG. 3b, planar sheet (26) includes passageways (27) and ribs (28). As shown in FIG. 3b, there is a straight line travel followed by a left shift, a right shift and another left shift, then another straight line segment, and these patterns may be repeated throughout the process. Almost any shifted pattern which eliminates all straight-line (clear view) passageways through the board should be included within the scope of the present invention to reduce the longitudinal weakness. Preferably, the external shift in at least some locations along the ribs are equal in distance to the distance between the ribs.

FIG. 3c shows a true sigmoid shifted pattern present invention board segment (36) with a planar shift (37), passageways (38), and a shifted pattern ribs (39).

FIG. 4 shows the hollow thermoplastic sheeting (11) of the present invention, which has plurality of ribs of sigmoid pattern (14). The production process disclosed in the present invention converts the longitudinally extending ribs of the prior art to ribs of sigmoid pattern (14). The modification of the rib configuration enhances (a) the tear strength of the hollow thermoplastic sheeting in the direction along the passageway, (b) the flexural or bending strength in the cross passageway direction and (c) the registration and quality of cutting or scoring lines, which in turn improves the efficiency of converting the sheeting to boxes.

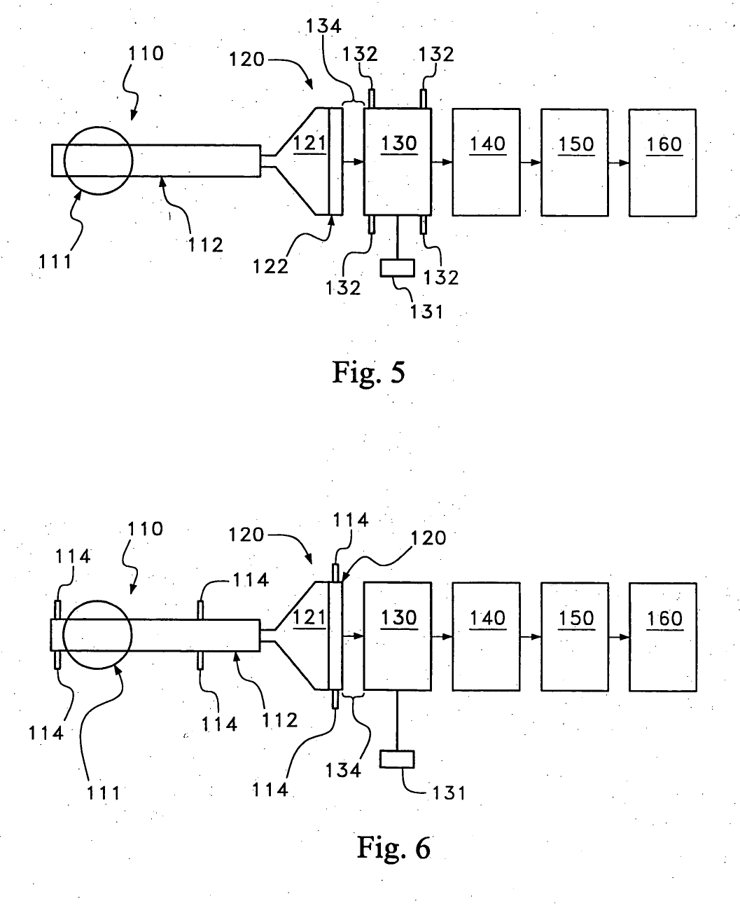

FIG. 5 illustrates the production process which manufactures the hollow thermoplastic sheets consist of a pair of sheets or layers (12) (13) spaced apart and interconnected by extending ribs of sigmoid pattern of this invention (14). The production process includes an extrusion assembly (110) for extruding thermoplastic materials, a die assembly (120) to form hollow boards of suitable configuration, a sizer and cooling assembly (130), which oscillates back and forth with preset moving function, to set the shape and dimension of the sheeting, a haul-off unit (140), an annealing unit (150) and apparatus for cutting the boards (160). According to the other embodiment of the production process, the sizer and cooling assembly (130) is fixed in position while the extrusion (110) and die assemblies (120) oscillate back and forth with preset moving function.

The extruder includes, hoppers (111) which receive solid thermoplastic pellets and other compositions that are directed into the barrel of a screw-type feeder where heat from the friction force or heater transforms the pallet material into a plastic state. The feeder moves the plastic material from the feeding section towards the die assembly (120) and forces the plastic material through the die assembly (120) to form boards of desired passageway structure. The molten extruded sheeting then travels through a short distance (134) between the face of the die assembly (120) to enter the sizer and cooling assembly (130), which oscillates back and forth according to a preset function. The sheeting exiting from the sizer and cooling assembly (130) passes between and is engaged by pairs of pulling rolls of the haul-off unit (140) which deliver the sheeting through annealing unit (150) and the cutting device (160). The annealing unit (150) contains heating oven to release induced stress and insure flatness of the board while the cutting apparatus (160) cuts the sheeting into its final dimension.

The thermoplastic material to make the hollow plastic sheeting made by the process of the present invention depends on the application for which they are intended. The thermoplastic materials include polyolefins such as polypropylene, linear or branched polyethylene and copolymers thereof; polystyrene and styrene copolymer of various kinds; polyvinyl chloride and its copolymers; acrylic resins; polycarbonate; polyethylene terephthalate and its copolymers; and so on.

It is needless to say that ingredients, which are usually used as additives in the thermoplastic material, can be appropriately employed if necessary in the present invention. These ingredients include fillers, such as glass fiber, talc, calcium carbonate, etc., which are usually used in plastic material to reinforce the mechanical properties and foaming agents, such as sodium bicarbonate, ammonium chloride and the like, which reduce the density of the plastic material while maintain specific properties. In addition, colorants, antistatic agents, ultraviolet light inhibitors, smoke suppressants, flame retardant, etc. may be incorporated in the thermoplastic material to enhance specific properties of the sheeting of the present invention.

Suitable apparatus means for the plastifying and extruding of the thermoplastic materials are known in the art. Generally, the plastifying and extruding steps can be carried out in a single apparatus such as a screw extruder (112). Referring to FIG. 5, the thermoplastic resin and additives of suitable proportion are charged into the hoppers of the extruder (112), plastified within the extruder cavity at a temperature above the fusion temperature of the thermoplastic polymer. The plastified and melted thermoplastic mass is then extruded through a die head (121) and die lip (122) at the end of the extruder (112) to form sheeting consisting of a pair of layers spaced apart and interconnected by extending ribs.

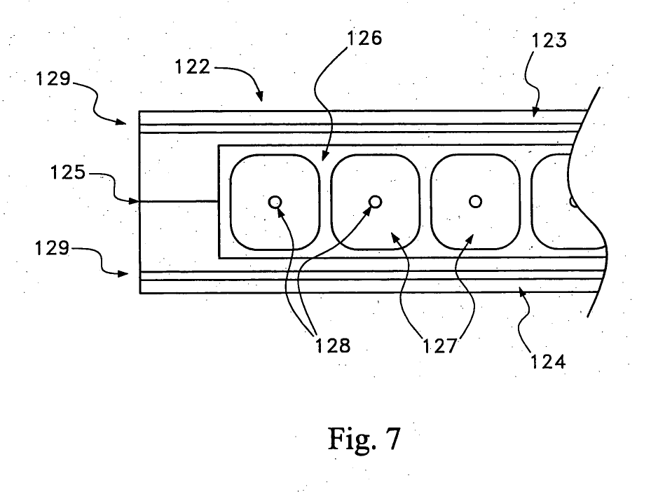

Referring to FIG. 7, the die lip (122) contains upper and lower die sections (123), (124), each having an electrical heater (129). Die sections (123) and (124) are secured in face-to-face relation along line (125) to form die cavity (126). The cross-section of cavity (126) corresponds to the external shape of board (1). Die sections (123), (124) are provided with cutouts, which receive mandrels (127). The mandrels are connected to a transverse mandrel holder, which secures and positions the mandrel (127) across cavity (120). Longitudinal bores (128) in mandrels (127) are connected to a transverse bore in the mandrel holder which extends transversely through the mandrel holder and communicates with venting facilities which provides air flow through passageways of the board (1) during extrusion.

After the die section, the molten thermoplastic sheeting travels a short distance (134) to the sizer and cooling assembly (130). The sizer and cooling assembly (130) contains top and bottom platens, which are provided with a plurality of extremely narrow slots, which communicate with manifolds. The manifolds are connected to a vacuum source (131), so that the reduced pressure within manifolds cause extrusion layers (2) and (3) of the hollow thermoplastic sheeting to be forced against the two platen surfaces, respectively. Thereby preventing collapse of layers (2) and (3) during the period when layers (2) and (3) and ribs (4) are in a plastic or semi-plastic state and set the final dimension of the thermoplastic boards. In addition, cooling tubes are imbedded behind the surfaces of the upper and lower platens. Cooling water is circulated in the cooling tubes to cool the surface of the thermoplastic sheeting. The cooling water is regularly controlled at a temperature from about 1 to about 30° C. The sizer and cooling assembly gradually solidifies while setting the dimension of the hollow thermoplastic sheeting.

The continuously extruded sheeting is then pulled away from the sizer and cooling assembly (130) by a haul-off unit (140).

In the prior art, the sizer and cooling assembly (130) are aligned with the extruder (112) and die assembly (120) in a fixed position. The hollow thermoplastic sheets thus produced have a plurality of ribs to form straight passageways. In the present invention, the sizer and cooling assembly (130) is equipped with moving means, which is supported by a plurality of wheels or bearings moving on a plurality of rails (132), which are parallel with each other and perpendicular to the moving direction of the extruded sheets. During the production of the hollow thermoplastic sheeting, the sizer and cooling assembly (130) moved back and forth according to a preset moving function. The top and bottom platens of the sizer and cooling assembly (130) tightly hold the extruded sheeting with vacuum and carry the sheeting to oscillate with the entire assembly according to the preset moving function. This oscillation may be achieved mechanically, e.g. by cams of fixed arrangements, of the process may be controlled by computer so that fixed, changing or complex shift patterns may be employed.

There is a short distance (134) of about 1 to 12 inches from the face of the die lip to the sizer and cooling assembly (130). The hollow thermoplastic sheeting is in a soft and molten state, when leaves the die lip (121), maintains at the same state in the short distance (134), and starts to solidify after entering the sizer and cooling assembly (130). In the molten state the hollow thermoplastic sheet can be easily shaped. Due to the relative movement of the die lip (121), which is fixed in position, and the sizer and cooling assembly (130), which is moving back and forth with a preset moving function, the continuously extruded sheeting in molten state is curved to bring forth a sheeting consist of a pair of flat layers spaced apart and interconnected by extended ribs of shifted pattern.

Referring to FIG. 6, in the other embodiment of the present invention, the sizer and cooling assembly (130) is fixed in position while the entire extrusion (110) and die assemblies (120) are provided with moving means, which are supported by a plurality of wheels or bearings and synchronically move back and forth according to a preset function on a plurality of rails (114) which are parallel to each other and perpendicular to the moving direction of the extruded sheets. The feeding system, such as hoppers, of the extruder moves with the extruder (112) and is connected to the resin or additives supplying facilities such as silos or containers with flexible hoses. As a result of the relative movement between the die lip (122) and sizer and cooling assembly (130), the sheeting section, which is between the die lip (122) and the sizer and cooling assembly (130) and is in molten state, is curved to form hollow thermoplastic sheeting of the present invention.

The sheeting is pulled outwardly at a constant speed by a haul-off unit (140). The haul-off unit is similar to the conventional pulling means in the extrusion of sheeting, such as those employing a plurality of groups of wheels having a resilient cover or those employing friction belt imposed on the top and bottom surfaces of the sheeting. The engaging surfaces, such as resilient covering or belt, have an adjustable gap between the surfaces, therefore, can be adapted to accommodate to the respective thickness of the sheeting.

The hollow thermoplastic board is quenched from molten state in the sizer and cooling assembly (130). Stress is built in the quenching process, especially for crystalline polymers. To release the induced stress, the hollow thermoplastic sheeting is annealed in an oven (150). The annealing process insures the flatness of the thermoplastic sheeting. This process is optional for non-crystalline plastic such as polyvinyl chloride.

After the hollow thermoplastic sheeting has left the annealing unit (150), the sheeting is cut at desired length by cutting machines (160) such as guillotine, saw, slitter or the like. In a manner well known in the art, the guillotine, knife or blade of the cutting machine moves at the same speed as that of the sheeting during the period when the guillotine, knife or blade performs the cutting step.

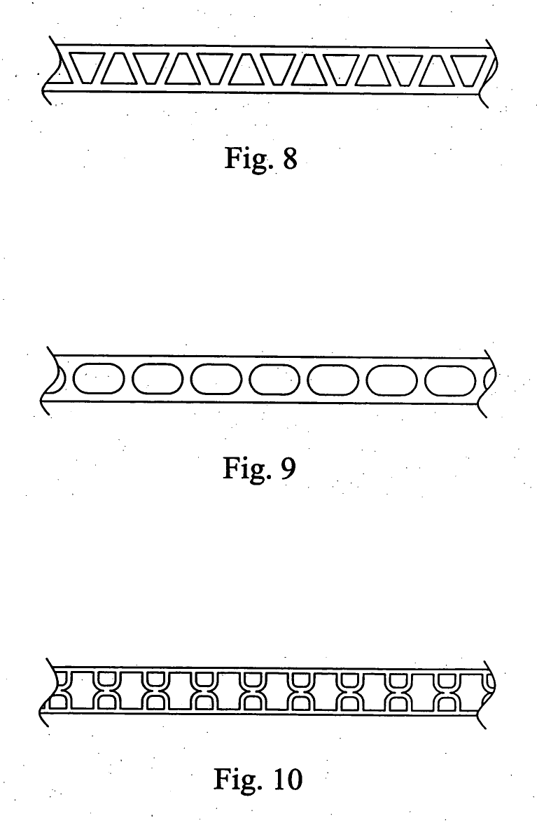

Though the hollow thermoplastic boards in the figures, which contain two planar sheets spaced apart and interconnected by extending vertical ribs is used as illustration of the present invention in the previous descriptions, obviously, numerous modifications and variations of the configuration of the hollow thermoplastic boards are possible in light of the above teachings. FIGS. 8 through 10 are sectional views of parts of several types of hollow thermoplastic boards, which can be made by the present invention. The examples in FIGS. 8-10 are illustrative of types of hollow thermoplastic boards can be made by the process of present invention and are not included as a limitation of the scope thereof.

### Properties of Hollow Thermoplastic Sheeting

The properties of the hollow thermoplastic boards produced by the present invention, described in conjunction with the Examples below are determined by the following methods.

Flat Crush Resistance (TAPPI-T 825): The flat crush resistance (hereinafter referred to as FCR) test is performed on a compression test machine having an upper and lower platen, one rigidly supported and the other driven. The hollow board of thermoplastic resin is cut in circular form of 32.3 cm² in area. The specimen is positioned centrally on the lower platen. Apply the crushing load to the specimen until the ribs of the boards collapse completely. Failure is defined as the maximum load sustained before complete collapse. Reported as the force per unit area.

Tear Resistance Strength (ASTM-D1922): The test measures the propagation of tear resistance by the pendulum method. The test specimen is a rectangle 76 mm (3 in.) in width by 63 mm (2.5 in.) in length. The 63-mm specimen dimension shall be the direction of tear. A slit 20 mm (0.8 in.) deep is made at the center of the edge perpendicular to the direction to be tested. The propagation of the tear resistance along the slit is then measured by the pendulum device described in ASTM D-1922. For hollow thermoplastic board, it is usually that only the tear resistance in the along the passageway direction is measured since the tear strength in the direction is weaker in compare with the strength in the cross passageway direction.

Flexural Strength: The flexural strength (hereinafter referred to as FS) test is similar to ASTM D-790. Due to the shifted rib structure of the hollow thermoplastic board in the present invention, the results measured from the standard test vary widely. To accommodate the wide variation, specimens of larger size are used. The test specimens are rectangles of 305 mm (12 in.) by 305 mm (12 in.) and 153 mm (6 in.) by 305 mm (12 in.) for sheeting of 8-10 mm and 3-4 mm in thickness, respectively. The speed of the crosshead to bend the test specimen is 0.01×L²/6d where L is the support span and d is the thickness. The maximum load force before the failure of the hollow thermoplastic board is defined as flexural strength. Both the flexural strengths in the cross passageway (CD) and along passageway directions (MD) of the boards are measured.

Compression Strength: The compression strength (hereinafter referred to as CS) test is similar to TAPPI T-811, which tests the edgewise compressive strength. Due to the wide variation of the test results, which is explained in flexural strength test, the test specimen is much larger than that in the standard test. The test specimen is 305 mm by 305 mm. Two special designed holders are attached to the crosshead of the compression equipment used in the bending test. The two holders of the compression equipment grip the two edges of the test specimen and compress with a crosshead speed of 0.1 inch/minute until the specimen fails. The displacement of the crosshead and the load are recorded for analysis. The maximum load before the test specimen fails is the compression strength. Both the compression strengths of the boards in the cross (CD) and along passageway directions (MD) are measured.

### EXAMPLES

The present invention will now be explained by the following examples. The boards were produced using the above-mentioned production process. To compare the properties of the hollow thermoplastic boards with ribs of shifted pattern of this invention with those of ribs of straight pattern, the boards were manufactured with the same operating conditions except that the sizer and cooling (130) or extrusion assembly (110) oscillates for the production of the boards with ribs of shifted pattern of this invention. The properties of the boards obtained were measured by methods described in the previous section. The following examples are illustrative of the present invention and are not included as a limitation of the scope thereof.

### Example 1

In the Example, the thermoplastic material used is polypropylene. The die configuration is as shown in FIG. 7. The extrusion temperatures are between 150 and 240° C. and the temperatures of the die range from 180 to 240° C. The temperatures across the die are usually higher in the edge sections and lower in the middle section. The board is later shaped and cooled in the sizer and cooling assembly at a temperature about 20° C. The sizer and cooling assembly is fixed in position and aligned with other units of the production line. The board produced has a thickness of about 8 mm and the weight per square meter is 1850 grams. The mechanical properties of the board are shown in Table 1.

### Example 2

In this Example, the same polypropylene as in Example 1 is used. The production equipment and operational conditions are the same except the sizer and cooling assembly is oscillating in the direction perpendicular to the extrusion direction. The maximum moving distance, which the sizer and cooling assembly moves in the direction perpendicular to the extrusion direction, and the time span to complete a full cycle are used to set the moving function of the sizer and cooling assembly. The hollow thermoplastic sheeting thus produced has rib structure of sigmoid pattern. The distance of the top and bottom of the sigmoid rib pattern of the hollow thermoplastic sheeting is the oscillating amplitude and the distance for a complete cycle is the oscillation pitch. The thickness and unit weight of the produced board are 7.96 mm and 1846 g/m², respectively, which are close to those of the board in example 1. The hollow thermoplastic sheeting thus produced has oscillation amplitude and pitch of 16 and 102 mm, respectively. The test results of the mechanical properties are tabulated in Table 1.

As shown in Table 1 that with the same thickness and unit weight, hollow thermoplastic board with ribs of sigmoid pattern substantially enhance the compression and flexural strengths in the cross passageway direction (CD) while the reduction of strengths in the along passageway direction is not significant. This significantly balances the physical properties of the hollow thermoplastic sheeting in the cross and along passageway directions.

### Example 3

In this Example, thermoplastic material is polypropylene with antistatic and ultraviolet protection additives. The die lip has the configuration as FIG. 7 and is suitable for production of hollow thermoplastic sheeting of thickness below 6 mm. The operation conditions are similar to those in Example 1. The sizer and cooling assembly is fixed in position and aligned with the other production units. The hollow thermoplastic board produced is 3.11 mm in thickness and has a unit weight of 678 gram/m². The physical properties of the thus produced sheeting are shown in Table 1.

### Example 4

In this example, the embodiment as shown in FIG. 6 is used to produce hollow thermoplastic boards containing ribs shifted pattern. After the samples in Example 3 are collected, the moving device of the extrusion and die assemblies is subsequently activated. The hollow thermoplastic boards collected are 3.27 mm thick and the unit weight is 697 g/m². The oscillation amplitude and pitch are 12 and 78 mm, respectively. The test results of the physical properties are tabulated in Table 1.

As can be seen from Table 1 that the production process of the present invention also helps to balance the physical properties in the cross and along passageway directions of hollow thermoplastic board of lower thickness. It is especially observed that the tear strength has increased of 27%. In the hollow thermoplastic sheeting of longitudinal extending ribs, the tear is propagated without obstruction while the tearing path is impeded by the sigmoid ribs of the present invention. As can be seen in Table 1, the production process of the present invention significantly improves the tear strength of the hollow thermoplastic sheeting.

TABLE 1

| | Example 1 | Example 2 | Example 3 | Example 4 |
|---|---|---|---|---|
| Thickness, mm | 8.07 | 7.96 | 3.11 | 3.27 |
| Unit Weight, g/ | 1850 | 1846 | 678 | 697 |
| m² | | | | |
| Oscillation | N/A | 16 | N/A | 12 |
| Amplitude, nm | | | | |
| Oscillation | N/A | 102 | N/A | 78 |
| Pitch, mm | | | | |
| FCR, psi | 148 | 169 | 200 | 178 |
| Tear Strength, | N/A | N/A | 2923 | 3712 |
| gram | | | | |
| CS in MD, lbf | 658 | 629 | N/A | N/A |
| CS in CD, lbf | 238 | 270 | N/A | N/A |
| FS in MD, lbf | 131 | 132 | 48.0 | 46.6 |
| FS in CD, lbf | 61 | 79 | 20.4 | 24.7 |

Obviously, numerous modifications and variations of the present invention are possible in light of the above teachings. It is therefore understood that within the scope of the appended claims, the invention may be practiced otherwise than as specifically described herein.

What is claimed is:

1. A process for producing a light weight hollow thermoplastic board having a first planar sheet and a second planar sheet which are spaced apart by and interconnected by longitudinally extended ribs having shifted patterns, which comprises:
extruding molten thermoplastic through an extruder having a die assembly with a die with a cavity having a cross-section corresponding to a desired external shape of a thermoplastic board and having mandrels within said cavity to create a soft board having a plurality of longitudinal passageways and ribs between a first planar sheet and a second planar sheet;
advancing the resulting soft board to a sizer and coller assembly to set the first dimensions of the soft board and cool it to a rigid board;
during said extruding and said advancing, oscillating one of said die assembly and said sizer and cooling assembly relative to one another in a predetermined sequence to cause said ribs to shift from a straight line path to eastablish a board with ribs of shifting patterns.

2. The process of claim 1 wherein said die assembly is stationary and said sizer and cooling assembly is oscillated.

3. The process of claim 2 wherein said sizer and cooling assembly is oscillated mechanically.

4. The process of claim 2 wherein said sizer and cooling assembly is oscillated by computer control.

5. The process of claim 1 wherein said die assembly is oscillated and said sizer and cooling assembly is atationary.

6. The process of claim 5 wherein said die assembly is oscillated mechanically.

7. The process of claim 5 wherein said die assembly is oscillated by computer control.

8. The process of claim 1 wherein said process further includes: annealing said rigid board in an oven.

9. The process of claim 1 wherein said board is made of thermoploastic polymer selected from the groups consisting of olefins, styrenes, vinyl chlorides, acrylics, carbonates and ethylene terephthalates.

10. The process of claim 9 wherein said thermoplastic polymer is selected from the group consisting of polypropylenes, linear polyethylene, branched polyethylene and copolymers thereof.
